(19) United States
(12) Patent Application Publication
(10) Pub. No.: US 2011/0069204 A1
(43) Pub. Date: Mar. 24, 2011

(54) METHOD AND APPARATUS FOR IMAGE CORRECTION

(75) Inventors: Dudi Vakrat, Netanya (IL); Haim Grosman, Sunnyvale, CA (US); Assaf Weissman, Haifa (IL)

(73) Assignee: Zoran Corporation, Sunnyvale, CA (US)

(21) Appl. No.: 12/888,296

(22) Filed: Sep. 22, 2010

Related U.S. Application Data
(60) Provisional application No. 61/244,974, filed on Sep. 23, 2009.

(51) Int. Cl. H04N 9/68; H04N 9/64

(52) U.S. Cl. 348/234; 348/249; 348/E09.053; 348/E09.037

(57) ABSTRACT

A method and apparatus are provided for correcting image data of an image sensor. In on embodiment, a method includes receiving sensor data including image data having at least one artifact and smear sensitive data, detecting motion of one or more light sources associated with the artifact and characterizing the motion of the one or more light sources to provide a motion characteristic. The method may further include correcting at least a portion of the image data based on the smear sensitive data and the motion characteristic of the one or more light sources, wherein the correcting is responsive to vertical motion and non-vertical motion of the one or more light sources.

### CROSS-REFERENCE TO RELATED APPLICATION

This application is based on and claims priority to Provisional Application No. 61/244,974 filed Sep. 23, 2009, the disclosure of which is incorporated herein in its entirety by reference.

### FIELD

The present disclosure relates in general to image processing and more particularly to correction of image data for one or more image artifacts due to overexposed pixels.

The present disclosure relates in general to image processing and more particularly to correction of image data for one or more image artifacts due to overexposed pixels.

### BACKGROUND

Many imaging devices employ charge coupled devices (CCDs) as image sensors to detect image data. Conventional methods and devices for CCD image detection typically employ an array of photo active regions, or pixels, for detecting image data. These conventional methods and devices, however, may be susceptible to overexposure of pixels due to one or more light sources detected by the imaging array. As such, the conventional methods and devices generate image data including one or more artifacts, such as smear.

Referring now to FIG. 1, a conventional CCD image array 100 comprising a plurality of columns is shown. The conventional methods and devices can read CCD data by clocking each of a plurality of columns one stage at a time towards the top of the column where the value is read from the last CCD cell of the column into a register from which the data corresponding to a particular row of the CCD image sensor is then read. Alternatively, data of the CCD image array may be read out in raster scan through a plurality of vertical shift registers (e.g., one vertical shift register for each column of pixels), followed by a horizontal shift register. Each time the vertical shift registers are clocked, a new line will be pushed into the horizontal shift register. Each time the horizontal shift register is clocked, a new pixel will be generated from the horizontal shift register, and from the sensor as a whole. As a result, an overexposed pixel will impact all pixels shifted into the register after the impacted pixel and appear as a smear artifact in the image

For video and preview capturing, image scenes containing a bright light source may contaminate one or more vertical shift registers, thereby causing pixels located below and above the light source to become brighter. The column of brighter pixels is called “smear.” It is also possible that an overexposed region of a CCD device will impact neighboring pixels to the left and right, and further bloom the impact of the overexposed region. Additionally, overexposed pixels can impact pixels all the way to the read register. Motion of light sources in a detection area of the CCD may additionally affect overexposure of various pixels horizontally across array 100.

Conventional methods of smear correction employ vertical correction of pixel data. However, these conventional methods do not address non-vertical motion of a light source across the plane of a detection array. The motion of a light source with respect to the CCD plane may be complex. Vertical motion (i.e., motion that is in the direction of the motion of the data as the captured image is read out through the sensor's vertical shift register) is dealt with in the prior art. However, there is no compensation for the non-vertical motions of the light source(s) and/or the image sensor and therefore the correction is at best partial and at times not detectable, and worst case erroneous.

Thus, there exists a desire to address correction of artifacts for CCD devices.

### BRIEF SUMMARY OF THE EMBODIMENTS

Disclosed and claimed herein, are methods and apparatus for correcting image data of an image sensor. In one embodiment, a method includes receiving sensor data, detected by the image sensor, wherein the sensor data includes image data and smear sensitive data, the image data including at least one artifact, detecting motion of one or more light sources associated with the artifact, characterizing the motion of the one or more light sources to provide a motion characteristic, and correcting at least a portion of the image data based on the smear sensitive data and the motion characteristic of the one or more light sources, wherein said correcting is responsive to vertical motion and non-vertical motion of the one or more light sources.

Other aspects, features, and techniques of this document will be apparent to one skilled in the relevant art in view of the following detailed description of the embodiments.

### BRIEF DESCRIPTION OF THE DRAWINGS

The features, objects, and advantages of the present document will become more apparent from the detailed description set forth below when taken in conjunction with the drawings in which like reference characters identify correspondingly throughout and wherein:

FIG. 1 depicts a graphical representation of a conventional charge coupled device (CCD) image array;

FIG. 2 depicts a simplified block diagram of a device for correction of image data according to one or more embodiments;

FIG. 3 depicts a simplified representation of a CCD array according to one embodiment;

FIG. 4 depicts process for image correction according to one embodiment;

FIGS. 5A-5B depict graphical representations of diagonal references according to one or more embodiments;

FIG. 6 depicts a graphical representation of a plurality of overexposure regions according to one embodiment;

FIG. 7 depicts a process for image correction according to one embodiment;

FIG. 8 depicts a process for image correction according to another embodiment; and

FIG. 9 depicts a simplified representation of a CCD array according to another embodiment.

### DETAILED DESCRIPTION OF THE EXEMPLARY EMBODIMENTS

One aspect is directed to correcting image data of an image sensor. In one embodiment image correction may be provided for vertical and/or non-vertical correction of the image data. According to another embodiment, a method is provided for correcting image data of an image sensor based on one or more overexposed pixels of the image sensor. As such, one or more image artifacts such as smear and/or bloom may be corrected. Additionally, image correction may be provided for one or more or global and local motion of one or more artifacts.

In one embodiment a method is provided which includes generating a diagonal reference based on the one or more overexposed pixels and generating a reference compensation image (RCI) based on the diagonal reference estimation and smear sensitive data (e.g., reference data), including one or more of optical black (OB) pixel data and dummy line data detected by the image sensor. As used herein, references to dummy line data may relate to smear sensitive dummy line data. The method may further include generating a compensation factor image (CFI) based on the RCI to correct one or more of the over exposed pixels.

According to another embodiment, an apparatus is provided including an image sensor, such as a charge coupled device (CCD) configured to allow for at least one of non-vertical and vertical correction. The apparatus may be configured to identify non-vertical motion of overexposed pixels and provide compensation relative to such motion in addition to the traditional vertical compensation. As a result, addressing the non-vertical motion aspects of one or more light sources and/or image sensor can provide improved image quality. The apparatus may additionally be configured to provide compensation for overexposed pixels associated with one or more of global and local motion associated with the imaging array.

### DESCRIPTION OF THE EXEMPLARY EMBODIMENTS

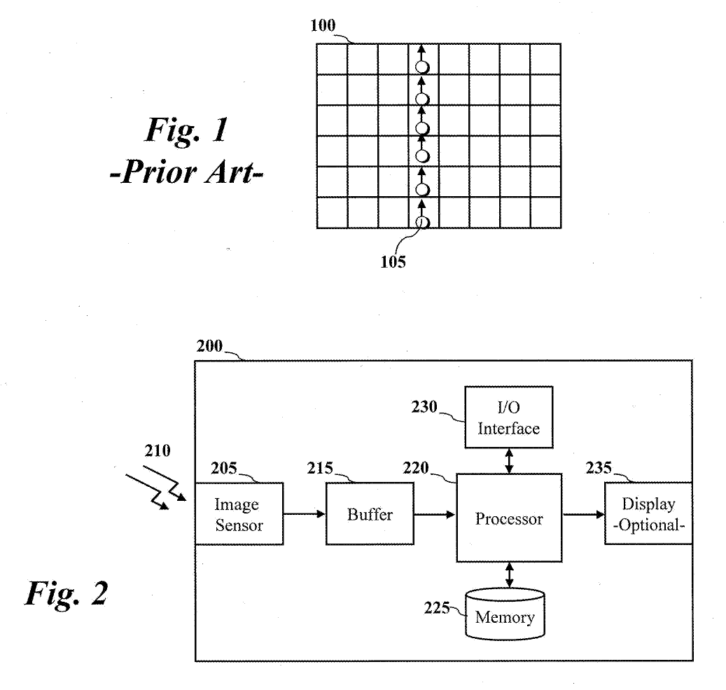

Referring now to the figures, FIG. 2 depicts a simplified block diagram of an imaging device according to one or more embodiments. According to one embodiment, device 200 may be configured to perform one or more of vertical correction and non-vertical correction of one or more pixels of detected image data. In certain embodiments, determining whether to perform vertical and/or non-vertical correction may be based on the motion of one or more overexposed pixels. Accordingly, device 200 may by configured to identify non-vertical motion of one or more overexposed pixels and provide compensation relative to such motion in addition to the traditional vertical compensation, when applicable. As a result, device 200 may address one or more artifacts, such as smear and/or bloom due to non-vertical motion of one or more the light source(s) to provide improved picture quality. According to another embodiment, device 200 may be configured to identify one or more of global and local motion of the one or more overexposed pixels to provide vertical and/or non-vertical compensation.

As shown in FIG. 2, device 200 includes image sensor 205 configured to detect incident light energy, shown as 210. In one embodiment, image sensor 205 relates to a charge coupled device (CCD) configured to output an array of pixel data. Based on the detected light energy, one or more of the pixels of the image sensor 205 may be addressed to generate a digital image. According to another embodiment, image sensor 205 may further include one or more optical black (OB) sections of the image array. The optical black sections may be masked from receiving external light energy to output a black value. As will be discussed in more detail below with respect to FIG. 3, image sensor 205 may include top optical black (TOB) and bottom optical black (BOB) sections. Device 200 may be configured to detect image data, via image sensor 205, related to image data for one or more frames. Image data detected by device 200 may relate to digital imagery, video imagery, etc. Buffer 215 may be configured to provide image data detected by image sensor 205 to processor 220, and may further be configured to temporarily store image data. In one embodiment, buffer 215 may relate to a shift register.

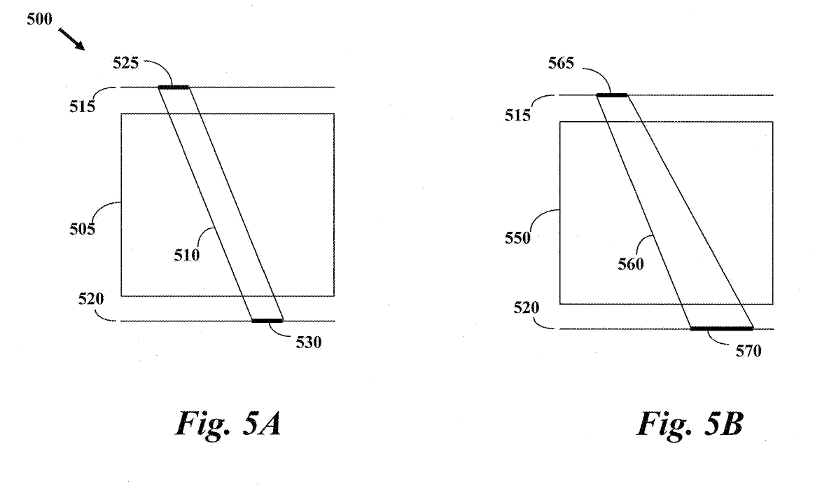

Processor 220 may be configured to detect one or more overexposed pixels and determine one or more correction factors for the one or more overexposed pixels of detected image data. By way of example, processor 220 may be configured to provide motion estimation of each light source associated with the overexposed pixel data to generate a diagonal reference as will be discussed in more detail below with respect to FIGS. 5A-5B. Processor 220 may then generate a reference compensation image (RCI) based on pixels associated with the diagonal reference. Processor 220 may then calculate a correction factor image (CFI) based on one or more RCIs for correction of image data. Processor 220 may relate to one of an application specific integrated circuit (ASIC), field programmable gate array (FPGA), and processor in general. As shown in FIG. 2, processor 220 is coupled to memory 225. Memory 225 may be configured to store one or more of executable instructions and intermediate results (e/g/. processed/non-processed image data) for processor 220, and relates to one of a RAM and ROM memory. In certain embodiments, device 200 may interoperate with external memory and/or interface with removable memory (not shown in FIG. 2).

Input/output (I/O) interface 230 of device 200 may be configured to receive one or more user commands and/or output data. For example, I/O interface 230 may include one or more buttons to receive user commands for the imaging device. Alternatively or in combination, I/O interface 230 may include one or more terminals or ports for receiving and/or output of data. In certain embodiments, device 230 includes optional display 235 configured to display detected image data, user interface, menu applications, etc. I/O interface 230 may output corrected image data.

As depicted in FIG. 2, elements of device 200 are shown as modules, however, it should equally be appreciated that one or more modules may relate to hardware and/or software components. Further, functions of the modules may relate to computer executable program code segments.

Referring now to FIG. 3, a simplified block diagram is depicted of a CCD array of the image sensor of FIG. 1 according to one embodiment. The CCD array includes pixel array 300 configured to detect incident light energy for one or more imaging applications. Pixel data may be accessed by shift register 305. According to another embodiment, array 300 may include one or more optical black pixels. As depicted in FIG. 3, array 300 includes top optical black (TOB) pixels 310 and bottom optical black (BOB) pixels 315. Optical black (OB) pixels may be masked from incident light energy to provide a black value to a processor of an image device. In certain embodiments, pixel array 300 may include a single optical black section, such as only one of TOB 310 and BOB 315. Pixel data associated with pixel array 300, TOB 310 and BOB 315 may be output by shift register 305, shown as 320. According to another embodiment, image correction of artifacts may be associated with TOB 310 and BOB 315 pixel values.

According to one embodiment, when it is time to output an image captured by pixels of array 300, one or more pixels are shifted vertically towards shift register 305 one shift per row. Output 320 of shift register 305 may be read either serially or in parallel to output the pixel data of a respective row. As such, array 300 may include a series of vertical shift registers under the sensing plane of array 300 to capture pixel data.

FIG. 3 additionally depicts one or more pixels which may be addressed to provide vertical correction according to one or more embodiments. For example, in order for pixels 325_{i,j} to be read, the pixel data moves first to row i−1, then row i−2, and eventually through TOB 310 rows until the pixel data reaches shift register 305 for reading. When pixel 325_{i,j} is overexposed, the following pixel gets overexposed once the overexposed pixel is shifted to pixel 325_{i-1,j}. Overexposed pixels may result from saturation due to over exposure of the pixel to one or more light sources. Overexposed pixels may be detected by comparing a pixel output level to a saturation threshold. In one embodiment, only OB pixel output levels are compared to the saturation threshold. Shifting of the overexposed pixel data can result in overexposed pixel data for an entire vertical line. As a result, a smear is read of the overexposed pixel to an entire column of the image.

According to one embodiment, a correction may be performed by pixel array 300 by measuring the values of the same column at TOB 310, and optionally at BOB 315, and reducing the value of the overexposed pixel from the black values to provide vertical correction. However, vertical correction typically only corrects vertical smearing. Because vertical correction can not accurately account for a moving light source or moving image sensor, and even more so when a plurality of light sources are made available, non-vertical correction may be provided according to one embodiment. Similarly, a correction performed on image data detected by pixel array 300 may be based on global and/or local motion of one or more light sources. Local motion may refer to motion of the light source itself, and therefore it is not necessarily the same for all light sources in the image (each light source can have its own motion characteristics). Local motion of a light source may affect a portion of the image data, such as a region of pixels within the frame based on a comparison of a first and second frame (e.g., past, current, future). Global motion is motion which is normally created by the movement of the camera, and therefore, it affects all light sources in the image.

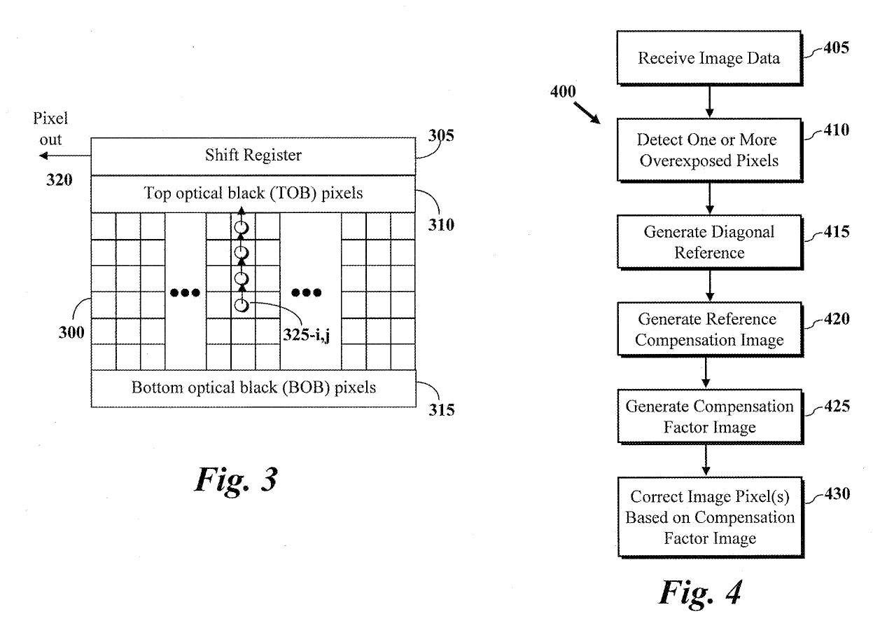

Referring now to FIG. 4, a process is depicted for image correction according to one or more embodiments. Process 400 may be performed by a processor (e.g., processor 220) of an imaging device to provide artifact correction according to one or more embodiments. In one embodiment, process 400 relates to non-vertical correction of one or more pixels of an image sensor, such as a CCD device. Process 400 may be initiated by receiving image data at block 405. In certain embodiments, the processor may determine if correction is needed based on the detection of one or more overexposed pixels. Accordingly, the processor may be configured to detect one or more overexposed pixels at block 410. In one embodiment, process 400 may be performed for a sequence of frames, where the index of the current frame is n, the index of the previous frame is n−1, the index of the next frame is n+1, and so on. Each frame includes a TOB line, and in certain cases a BOB line as well, as not all CCDs include a BOB line.

Detection of the one or more overexposed pixels may include determining motion associated with the one or more overexposed pixels. According to one embodiment, following detection of one or more exposed pixels, process 400 may include correction of the overexposed pixels. Correction of the overexposed pixels may be based one or more of vertical and non-vertical correction. In certain embodiments, a processor of the imaging device may determine the type of correction based on estimation of the motion of one or more light sources associated with the over exposure, as each light source in the image creates a smear column. As such, the shape of the smear column (e.g., vertical/diagonal/other) may depend on the motion characteristics of a particular light source, from the time the top row of the image was read out, to the time the bottom row of the image was read out. The processor may be configured to estimate motion in three dimensions: horizontal, vertical and distance from camera (where the light source moves closer towards the camera or further away from the camera). In each direction speed of the light source may not necessarily be constant. For example, a light source getting closer to the camera will create a trapeze shaped smear column (e.g., narrow at the top, and wider at the bottom), while a light source with constant horizontal motion can create diagonal smear column. Similarly, a light source accelerating horizontally can create diagonal smear column with some curvature in that an angle of the column will be moderate at the top, and stronger at the bottom. Other types of motion may be related to changes in the nature of the light source. For example, a light source with variable intensity, angle, size, shape, etc.

Process 400 may employ motion estimation based on an image itself and/or on optical black (OB) lines. In one embodiment, motion estimation is based on one or more optical black (OB) lines, that is TOB lines, BOB lines, or both. Additionally, motion estimation may be based on one or more of a current frame, previous frame(s), and future (e.g., subsequent) frame(s). In one embodiment, motion estimation may be performed by comparing BOB lines of a current frame to TOB lines of a current frame. In the absence of BOB lines, motion estimation may be performed by comparing one or more TOB lines of a subsequent frame to TOB lines of a current frame. Similarly, motion estimation may be based on comparison of a TOB line of a subsequent frame to a TOB line of current frame. When correction must be done on the fly (e.g., when future information is not available), motion estimation may be based on a comparison of TOB lines of current frame to TOB lines of the previous frame, using OB lines further away in the past, and/or in the future for that matter. OB data further away in the past (or future) can be included in the estimation in order to estimate acceleration, deceleration, rather than just constant motion. It should also be appreciated that other types of motion estimation may be employed.

In order to correct the overexposed pixel data, the processor may generate a diagonal reference at block 415. In one embodiment, reference TOB (RTOB) lines may be created. For example, the RTOB lines may be employed as TOB lines. Alternatively, the RTOB lines may be generated by taking the TOB lines and performing a noise reduction. Noise reduction can be spatial, temporal or both. The processor may be configured to provide a temporal filter that is motion compensated. Temporal filtering may include pixel data from other OB lines in addition to the TOB lines of the current frame. As a result, the RTOB lines may be generated by taking a subset of TOB/BOB lines from current/future/past frames and performing processing on this subset in order to generate RTOB lines for the current frame.

At block 420, a reference compensation image (RCI) may be generated based on the RTOB lines and the motion characteristics of each light source. Alternatively, or in combination, the RCI may be generated based on dummy line data detected by the image sensor. In one embodiment, motion may be described by a horizontal motion vector, and there is only one RTOB line. In this case for each row in the image, from top to bottom, the RTOB line may be shifted a little further to the right or to the left (depending on the direction of the motion) thereby creating a diagonal reference image. The amount of pixels by which the RTOB line needs to be moved for each row in the image may be calculated by dividing the horizontal motion vector by the numbers of rows in the image. Interpolation can be used in order to move the RTOB line in sub-pixel accuracy.

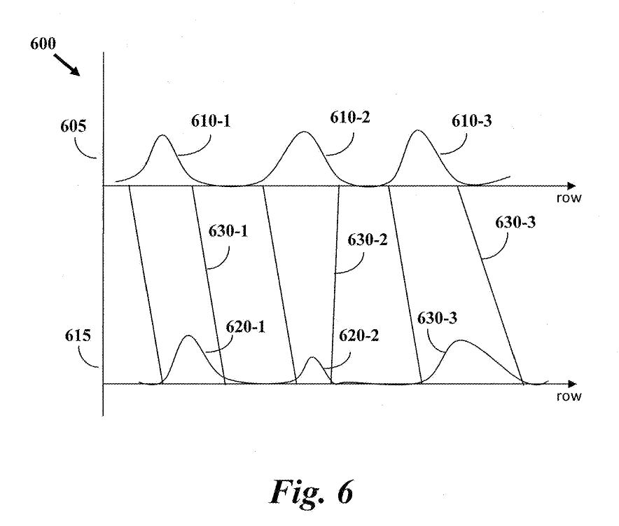

When multiple light sources are detected, calculation of reference image may be repeated for each light source. The results of the reference image calculation may be summed to produce a single reference image (RCI). A constant offset may have to be subtracted from the final reference image. The differentiation into a plurality of light sources is discussed herein below with respect to FIG. 6.

Alternatively to, or in combination with, calculation of RTOB lines, process 400 may include creating reference BOB lines (RBOB lines) at block 415. The RBOB lines may be created in a similar way to the RTOB lines. For example, the RBOB lines may be used as the BOB lines themselves. When BOB lines do not exist, the TOB lines of the next frame can be used. Hence, the exemplary and non-limiting RBOB lines may be generated by taking a subset of TOB/BOB lines from current/future/past frames and performing any kind of processing on this subset in order to generate RBOB lines for the current frame.

In one embodiment, an RCI may be generated based on RBOB lines and the motion characteristics of each light source. In this case the RBOB lines are taken instead of the RTOB lines, and the reference image is generated from bottom to top using reversed motion vectors.

A compensation factor image (CFI) may be generated at block 425 based on the RCI. In one embodiment, a weighted average may be performed between the RCI generated from RTOB lines and the RCI generated from RBOB lines in order to determine a compensation image (CI). Weight changes may be calculated for each row in the image by the processor. According to another embodiment, the weight of the reference image generated from RTOB lines will be stronger for the top image lines, and the weight of the reference image generated from RBOB lines will be stronger for the bottom image lines.

The processor may be configured to correct one or more overexposed pixels based on the CFI at block 430 by subtracting of a final reference image from the current image, in order to correct a smear artifact(s). According to another embodiment, the correction is not a simple subtraction but rather a selective and weighted subtraction. For example, in certain embodiments saturated image pixels (e.g., pixels assigned the maximum value according to the dynamic range of a sensor) will not be corrected according to the CFI in order to prevent over-correction. In other embodiments, saturated and/or overexposed pixels may be compensated by the CFI.

Referring now to FIGS. 5A-5B, graphical representations are depicted of a diagonal reference according to one or more embodiments. According to one embodiment, a diagonal reference may be employed for non-vertical correction. Referring first to FIG. 5A, a pixel array 505 is shown including a light source moving horizontally (e.g., from left to right) with respect to the sensor causing a diagonal impact, shown as 510. Compensation based solely on vertical motion can not correct for this type of motion by a light source on array 505. Thus, according to one or more principles of this document, motion of a light source may be compensated by creating a diagonal reference. It should be appreciated that opposite motion of the image sensor and a light source, or any combination thereof, may also be compensated by creating a diagonal reference, for example, from top left to bottom right.

In one embodiment, diagonal reference 510 may be generated based on top optical black (TOB) line 515 for a first row of the CCD, each row in array 505 (e.g., from top to bottom) may be shifted to the right, for example, by means of interpolation. Alternatively, diagonal reference 510 may be generated beginning from bottom optical black (BOB) line 520 and then shifting for each row in the image (e.g., from bottom to top) to the left by means, for example, of interpolation. A reference compensation image (RCI) may then be generated by the processor of the imaging device that corresponds to diagonal reference 510.

According to another embodiment, two RCIs may be generated and then merged, pixel by pixel using a factor which gives more value to the compensation of the TOB 525 for lines closer to the top and giving higher compensation to the BOB for lines closer to the bottom, BOB 530. The compensation factor may be calculated as follows:

CF=BVt*α+BVb*(1−α)

Where α is a factor proportional to the position of the row, (e.g., for the first row closest to TOB 525 the value of α is approximately 1, and for the last row of array 505 α is approximately 0.) BVt relates to a black value for compensation at TOB line 515 for a respective pixel while BVb is the value for the BOB line 520 for a respective pixel. Accordingly, the compensation factor (CF) to be used with respect to a pixel of each row depends on its position within the sensor both vertically and horizontally. In that fashion, the deficiencies of the conventional methods and devices may be overcome. It should also be noted that as diagonal reference 510 is determined, compensation may be provided to pixels within the diagonal reference path, and pixels requiring compensation.

Referring now to FIG. 5B, light source motion is depicted as moving not only horizontally, but also approaching a CCD plane. According to one embodiment, a stretch or upscale may be provided by the processor for lines the RCI may be determined from. Similarly, a contraction or downscale may be provided for TOB and BOB lines. For example, as shown in array 550, one or more of TOB lines 565 and BOB lines 570 may be stretched or contracted. As shown in FIG. 5B, BOB lines 570 for generation of an RCI may be contracted.

According to another embodiment, when two RCIs are created for an array, a combined RCI may be generated. It should also be noted that other non-vertical motions possible for one or more light sources with respect to the image sensor plane may be similarly corrected. In one embodiment, the processor may generate a CFI based on the RCI data and subtracting pixel by pixel the value of the corresponding value of CFI from the pixel.

Referring now to FIG. 6, a graphical representation is depicted of a plurality of overexposed pixels according to one embodiment. Graphical representation 600 includes overexposed pixel data 605 associated with a TOB line and overexposed image data associated with a BOB line 615. In certain instances, more than one light source may cause over exposure of pixels. As depicted in FIG. 6, over exposure of pixels may be first identified at positions 610-1, 610-2 and 610-3 of TOB 605. Similarly, over exposure of pixels may be identified at positions 620-1, 620-2 and 620-3 of BOB 615. Each light source may cause a different effect due to different motion with respect to an image sensor. Accordingly, diagonal references 630-1, 630-2 and 630-3 may be determined to provide a correction on the pixels in the path of each of the light sources by a processor (e.g., processor 220) of the imaging device. Furthermore, operation in correction stripes will ensure that the correction process is performed only on the strips requiring correction thereby reducing DRAM access and bandwidth therefore also reducing power consumption for this operation

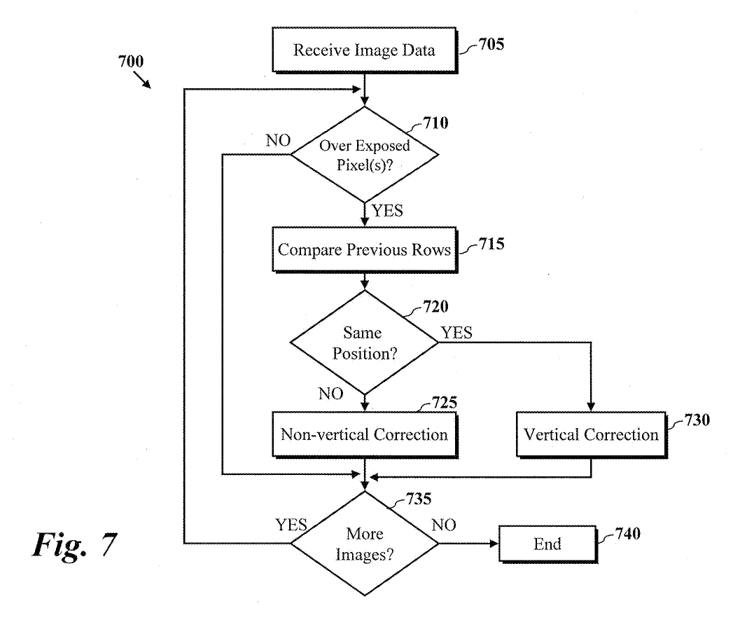

Referring now to FIG. 7, a process is depicted for image correction according to one or more embodiments. According to one embodiment, process 700 may be performed by the processor (e.g., processor 220) of an imaging device. Process 700 may be initiated by receiving image data at block 705. Image data received at block 705 may relate to image data received from a CCD (e.g., image sensor 205). At decision block 710, the processor may determine if one or more pixels of an image array are overexposed. When the processor detects overexposed pixel data (“NO” path out of decision block 710), the processor check for additional image data at decision block 735. When the processor detects overexposed pixel data (“YES” path out of decision block 710), the processor may compare pixel data to one or more previous rows at block 715 to determine if the overexposed pixels are in the same position (e.g., implying that there is only a vertical motion). At decision block 720, the processor may determine if the overexposed pixel data is in the same position by comparing pixel data to one or more previous rows. When the overexposed pixel data is in the same row (“YES” path out of decision block 720), the processor may perform vertical correction at block 730. Alternatively, when the overexposed pixel data is not in the same row (“NO” path out of decision block 720), the processor may perform non vertical correction at block 725. Non-vertical correction at block 725 may include multiple light source corrections. In certain embodiments, corrections may only be performed after an entire captured frame has been stored in memory. As such, the bottom and top correction values are known. It may also be appreciated that correction may be based on identification of at least one of global and local motion of overexposed pixel data. At decision block 735, the processor can check for additional image data. When additional data exists (“YES” path out of decision block 735), the processor may check for overexposed pixels at block 710. Alternatively, when additional data does not exist (“NO” path out of decision block 735), the correction process ends at block 740.

According to another embodiment, a temporal filter is added to address the noise that is associated with the correction line of the light source(s), especially when low levels of light are also involved. However such temporal filter for reduction of noise of the low level lights is problematic when used with the overexposed pixels. Therefore, at the areas where compensation is performed for over-exposure the temporal filter for reducing noise for low level light is suspended and applied again only for such areas that no over-exposure correction is performed.

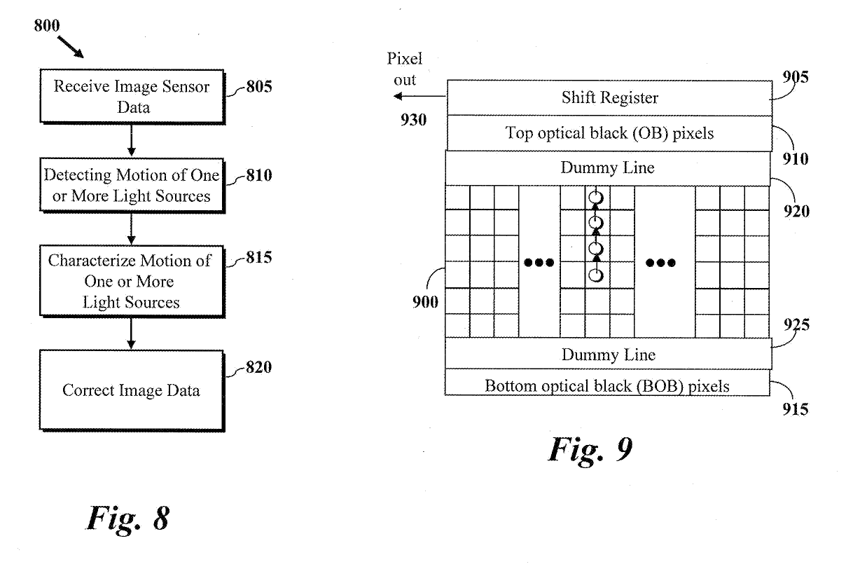

Referring now to FIG. 8, a process is depicted for image correction according to one or more embodiments. Process 800 may be performed by a processor (e.g., processor 220) of an imaging device to provide artifact correction according to one or more embodiments. In one embodiment, process 800 relates to correction of one or more smear artifacts associated with one or more light sources in the image. In movie and/or preview modes, in case the image contains a very bright light source, it may contaminate one or more vertical shift registers, thereby causing pixels located below and above the light source to become brighter. This column of brighter pixels is called “smear”. In case the light source moves with respect to the camera (or vice versa) the smear artifact may not appear as a vertical column. Instead, it may appear as diagonal column, or it may gain some curvature depending on the nature of the movement. Accordingly, process 800 may be responsive to vertical and non-vertical motion.

Process 800 may be initiated by receiving sensor data (e.g., image sensor data) at block 805. In one embodiment, sensor data may include image data associated with pixel array output (e.g., pixel array 300) and smear sensitive data including one or more of optical black data and dummy line data. The processor may determine if correction is needed based on the detection of one or more artifacts, such as smear. Accordingly, the processor can detect motion of one or more light sources associated with the artifact at block 810. Following motion detection of one or more artifacts, process 800 may characterize motion of the one or more light sources at block 815. In certain embodiments, a processor of the imaging device may determine motion characteristics associated with vertical and/or non-vertical motion. Characterization of light source motion may be based on smear sensitive data (e.g., optical black data (OB)), such as top and bottom optical black (OB) data. In certain embodiments, characterization of light source motion may be based on one or more of dummy line data and OB data. In another embodiment, motion may be described by a horizontal motion vector. When multiple light sources are detected, calculation of a reference may be repeated for each light source, and then all references will be combined to create the final reference image. Characterizing the motion may be based on one or more of current, past, and future frames detected by the image sensor.

The processor may be configured to correct image data at block 820. In one embodiment, correction of image data may be based on motion characteristics of one or more light sources and one or more of OB data and dummy line data. Smear sensitive data, such as OB data and dummy line data, may be processed prior to characterizing motion and/or correcting image data for spatial/temporal noise reduction, defective pixel removal, etc. According to another embodiment, correction of the image data may include correction for a portion, or correction for the entire image. At least a portion of the image data may be corrected by subtracting pixels associated with the reference image from the pixels associated with the image data.

According to another embodiment, correction of the image data may be based on a reference. In order to correct the artifact, the processor may generate a reference, such as a reference pixel. For example, when correction of the image data is performed on pixel by pixel basis, pixel may be corrected based on a pixel reference. Correction on a pixel by pixel basis may relate to calculating a reference pixel for each image pixel based on TOB, another reference pixel is calculated based on BOB, and the two references are merged into one final reference pixel. The pixel may then be corrected according to the reference pixel before proceeding to another pixel. In that fashion, pixel corrections may be calculated on the fly on a pixel by pixel basis. The reference may be responsive to vertical motion and non-vertical motion.

In another embodiment, reference images may be generated based on OB data and the motion characteristics of each light source to correct at least one artifact. Generating a reference image may include generating a plurality of reference images associated with a plurality of light sources, wherein the reference image is generated based on a combination (e.g., weighted average) of the plurality of reference images. The results of the reference image calculations may be summed to produce a single reference image. Alternatively to, or in combination with, calculation of a reference image, process 800 may include creating a reference OB line (RBOB and/or RTOB line). In one embodiment, the reference image may include diagonal or vertical columns of overexposed pixels, such that the diagonal columns reflect non-vertical motion of a light source. According to another embodiment, the reference image may be generated based on data associated with one or more dummy lines.

Referring now to FIG. 9, a simplified block diagram is depicted of a CCD array of the image sensor of FIG. 1 according to another embodiment. In certain embodiments, an image sensor may be configured to generate one or more dummy lines. A dummy line may relate to a line of image data generated by the sensor as frame readout. For example, dummy line data may not actually be detected by sensors of the image sensor as physical sensor lines such as image lines or OB lines. In contrast, dummy lines may be generated as part of frame readout. In contrast to OB data, dummy line data does not include black level information (e.g., data detected while shielded from a light source). Dummy line data may be employed as smear sensitive data and may be employed alone or in addition to OB data for correction of one or more artifacts.

The image sensor of FIG. 9 includes pixel array 900 configured to detect incident light energy for one or more imaging applications. Pixel data may be accessed by shift register 905. According to another embodiment, the image sensor may include one or more optical black pixels, depicted as 910 and 915. In certain embodiments, however, it may be appreciated that optical black pixels 910 and 915 are optional. As such, image data may be corrected based on dummy line data. As depicted in FIG. 9, the image sensor further includes dummy lines 920 and 925. Pixel data associated with pixel array 900, TOB 910 and BOB 915, and dummy lines 920 and 925 may be output by shift register 905, shown as 930. According to another embodiment, image correction of artifacts may be based on pixel values associated with dummy lines 920 and 925. In certain embodiments, dummy line data may be employed for generating one or more of a reference, reference image, and a reference compensation image (RCI). It should be appreciated that dummy lines depicted as 920 and 925 may relate to lines of image data generated by the sensor as frame readout, however, dummy lines 920 and 925 may not correspond to actual lines of a sensor array.

One or more embodiments described herein may relate to or reference OB data. It should be appreciated, however, that references to one or more embodiments referring to OB data may similarly be performed and/or employ dummy line data (e.g., smear sensitive dummy line data) in addition to or alternatively to OB data.

While certain exemplary embodiments have been described and shown in the accompanying drawings, it is to be understood that such embodiments are merely illustrative of and not restrictive on the broad embodiments, and that the embodiments not be limited to the specific constructions and arrangements shown and described, since various other modifications may occur to those ordinarily skilled in the art. Trademarks and copyrights referred to herein are the property of their respective owners.

What is claimed is:

1. A method for correcting image data of an image sensor, the method comprising the acts of:
receiving sensor data, detected by the image sensor, wherein the sensor data includes image data and smear sensitive data, the image data including at least one artifact;
detecting motion of one or more light sources associated with the artifact;
characterizing the motion of the one or more light sources to provide a motion characteristic; and
correcting at least a portion of the image data based on the smear sensitive data and the motion characteristic of the one or more light sources, wherein said correcting is responsive to vertical motion and non-vertical motion of the one or more light sources.

2. The method of claim 1, wherein the at least one artifact relates to one or more smear artifacts.

3. The method of claim 1, wherein the smear sensitive data relates to optical black data (OB) including one or more of top and bottom optical black (OB) data.

4. The method of claim 1, wherein the smear sensitive data relates to dummy pixel data including one or more of top and bottom dummy pixel lines.

5. The method of claim 1, wherein characterizing said motion is further based on at least one of smear sensitive data and image data for one or more of current, past, and future frames detected by the image sensor.

6. The method of claim 1, wherein correcting at least a portion of the image data includes calculating a reference for image pixels based on said motion and one or more of optical black data and dummy line data, wherein the reference is responsive to vertical motion and non-vertical motion, and correction is based on the reference to correct the artifact.

7. The method of claim 1, wherein correcting at least a portion of the image data includes generating a reference image to correct at least one artifact based on the motion characteristics and one or more of optical black (OB) data and dummy line data, the reference image responsive to vertical motion and non-vertical motion.

8. The method of claim 7, wherein the reference image includes one of diagonal and vertical columns of overexposed pixels, such that diagonal columns reflect non-vertical motion of the light source.

9. The method of claim 7, wherein generating a reference image includes generating a plurality of reference images associated with a plurality of light sources, wherein the reference image is generated based on a combination of the plurality of reference images.

10. The method of claim 7, wherein correcting at least a portion of the image data relates to subtracting pixels associated with the reference image from the pixels associated with the image data.

11. The method of claim 1, wherein correcting at least a portion of the image data relates to correcting an entire image.

12. The method of claim 1, further comprising processing the smear sensitive data prior to one or more of said characterizing motion and said correcting, wherein the smear sensitive data relates to one or more of optical black (OB) data and dummy line data.

13. The method of claim 1, wherein the at least one artifact is associated with one or more overexposed pixels associated with the one or more light sources.

14. An apparatus for processing image data, the apparatus comprising:
an image sensor for detecting image data and smear sensitive data;
a memory; and
a processor, the processor configured to
receive sensor data, wherein the sensor data includes image data and smear sensitive data, the image data including at least one artifact;
detect motion of one or more light sources associated with the artifact;
characterize the motion of the one or more light sources to provide a motion characteristic; and
correct at least a portion of the image data based on the smear sensitive data and the motion characteristic of the one or more light sources, wherein said correcting is responsive to vertical motion and non-vertical motion of the one or more light sources.

15. The apparatus of claim 14, wherein the at least one artifact relates to one or more smear artifacts.

16. The apparatus of claim 14, wherein smear sensitive data relates to optical black data (OB) including one or more of top and bottom optical black (OB) data.

17. The apparatus of claim 14, wherein the smear sensitive data relates to dummy pixel data including one or more of top and bottom dummy pixel lines.

18. The apparatus of claim 14, wherein characterizing said motion is further based on at least one of smear sensitive data and image data for one or more of current, past, and future frames detected by the image sensor.

19. The apparatus of claim 14, wherein correcting at least a portion of the image data includes calculating a reference for image pixels based on said motion and one or more of optical black data and dummy line data, wherein the reference is responsive to vertical motion and non-vertical motion, and correction is based on the reference to correct the artifact.

20. The apparatus of claim 14, wherein correcting at least a portion of the image data includes generating a reference image to correct at least one artifact based on the motion characteristics and one or more of optical black (OB) data and dummy line data, the reference image responsive to vertical motion and non-vertical motion.

21. The apparatus of claim 20, wherein the reference image includes one of diagonal and vertical columns of overexposed pixels, such that diagonal columns reflect non-vertical motion of the light source

22. The apparatus of claim 20, wherein generating a reference image includes generating a plurality of reference images associated with a plurality of light sources, wherein the reference image is generated based on a combination of the plurality of reference images.

23. The apparatus of claim 20, wherein correcting at least a portion of the image data relates to subtracting pixels associated with the reference image from the pixels associated with the image data

24. The apparatus of claim 14, wherein correcting at least a portion of the image data relates to correcting an entire image.

25. The apparatus of claim 14, wherein the processor is further configured to process the smear sensitive data prior to one or more of characterizing motion and correcting, wherein the smear sensitive data relates to one or more of optical black (OB) data and dummy line data

26. The apparatus of claim 14, wherein the at least one artifact is associated with one or more overexposed pixels associated with the one or more light sources.

27. A method for correcting image data of an image sensor, the method comprising the acts of:
receiving image data for a first frame;
detecting one or more overexposed pixels in the image data;
generating a diagonal reference based on the one or more overexposed pixels;
generating a reference compensation image (RCI) based on the diagonal reference estimation and optical black (OB) pixel data of the image sensor;
generating a compensation factor image (CFI) based on the RCI; and
correcting image data for one or more pixels based on the CFI.

28. The method of claim 27, wherein the one or more overexposed pixels are associated with one or more light sources in the first frame.

29. The method of claim 27, wherein the diagonal reference is associated with non-vertical image correction.

30. The method of claim 27, wherein the RCI is generated based on one or more of a reference top optical black (RTOB) line, reference bottom optical black (RBOB) line and dummy line data.

31. The method of claim 27, further comprising one or more of stretching and contracting optical black lines to determine the RCI.

32. The method of claim 27, further comprising determining a plurality of reference compensation images (RCIs) associated with a plurality of light sources, wherein the CFI is based on a comparison of the plurality of reference compensation images.

33. The method of claim 32, wherein comparison of the plurality of reference compensation images includes a weighted comparison of the plurality of reference compensation images to determine the CFI.

34. The method of claim 27, wherein correcting image data based on the CFI includes weighting pixel values for one or more overexposed pixels.

35. An apparatus for processing image data, the apparatus comprising:
an image sensor for detecting image data for a first frame;
a memory; and
a processor, the processor configured to
detect one or more overexposed pixels in the image data;
generate a diagonal reference based on the one or more overexposed pixels;
generate an reference compensation image (RCI) based on the diagonal reference estimation and optical black (OB) pixel data of the image sensor;
generate a compensation factor image (CFI) based on the RCI; and
correct image data for one or more pixels based on the CFI.

36. The apparatus of claim 35, wherein image sensor relates a charged coupled device (CCD).

37. The apparatus of claim 35, wherein the one or more overexposed pixels are associated with one or more light sources in the first frame.

38. The apparatus of claim 35, wherein the diagonal reference is associated with non-vertical image correction.

39. The apparatus of claim 35, wherein the RCI is generated based on one or more of a reference top optical black (RTOB) line, reference bottom optical black (RBOB) line and dummy line data.

40. The apparatus of claim 35, wherein the processor is further configured for one or more of stretching and contracting optical black lines to determine the RCI.

41. The apparatus of claim 35, wherein the processor is further configured to determine a plurality of reference compensation images (RCIs) associated with a plurality of light sources, wherein the CFI is based on a comparison of the plurality of reference compensation images.

42. The apparatus of claim 41, wherein comparison of the plurality of reference compensation images includes a weighted comparison of the plurality of reference compensation images to determine the CFI.

43. The apparatus of claim 35, wherein the processor is further configured correct image data based on the CFI by weighting pixel values for one or more overexposed pixels.

44. A method for correcting image data of an image sensor, the method comprising the acts of:
receiving image data for a first frame;
detecting one or more overexposed pixels in the image data;
determining if one or more of a vertical and non-vertical correction should be performed on the image data the based on the one or more overexposed pixels, wherein performing a non-vertical correction includes
generating a diagonal reference based on the one or more overexposed pixels;
generating a reference compensation image (RCI) based on the diagonal reference estimation and optical black (OB) pixel data of the image sensor;
generating a compensation factor image (CFI) based on the RCI; and
correcting image data for one or more pixels based on the CFI.

45. The method of claim 44, wherein the one or more overexposed pixels are associated with one or more light sources in the first frame.

46. The method of claim 44, wherein the RCI is generated based on one or more of a reference top optical black (RTOB) line, reference bottom optical black (RBOB) line and dummy line data.

47. The method of claim 44, further comprising one or more of stretching and contracting optical black lines to determine the RCI.

48. The method of claim 44, further comprising determining a plurality of reference compensation images (RCIs) associated with a plurality of light sources, wherein the CFI is based on a comparison of the plurality of reference compensation images.

49. The method of claim 49, wherein comparison of the plurality of reference compensation images includes a weighted comparison of the plurality of reference compensation images to determine the CFI.

50. The method of claim 44, wherein vertical correction of the one or more pixels includes comparing top optical black (TOB) and bottom optical black (BOB) lines.
